(19) United States
(12) Patent Application Publication
(10) Pub. No.: US 2012/0212445 A1
(43) Pub. Date: Aug. 23, 2012

(54) Display With Rear Side Capacitive Touch Sensing

(75) Inventors: Marko K. Heikkinen, Tampere (FI); Mika Antila, Pirkkala (FI); Markku Salmela, Vesilahti (FI); Klaus Melakari, Oulu (FI)

(73) Assignee: Nokia Corporation

(21) Appl. No.: 13/032,915

(22) Filed: Feb. 23, 2011

(51) Int. Cl. G06F 3/045; G09G 3/32

(52) U.S. Cl. 345/174; 345/82

(57) ABSTRACT

An apparatus including an electronic display having an electrical display section located behind a front window. A capacitive touch sensor located behind the electrical display section. The electrical display section is configured to display information to a user at the front window. The capacitive touch sensor is configured to sense presence of a finger of the user at the front window.

### BACKGROUND

1. Technical Field

The exemplary and non-limiting embodiments relate generally to an electronic display and, more particularly, to a touch sensor behind an electrical display section of the electronic display.

2. Brief Description of Prior Developments

Capacitive sensing is a technology based on capacitive coupling that is used in many different types of sensors, including those for detecting and measuring: proximity, position or displacement, humidity, fluid level, and acceleration. Capacitive sensing as a human interface device (HID) technology, for example to replace the computer mouse, is becoming increasingly popular. Capacitive sensors are used in devices such as laptop trackpads, MP3 players, computer monitors, cell phones and others.

Capacitive sensors detect anything which is conductive or having dielectric properties. While capacitive sensing applications can replace mechanical buttons with capacitive alternatives, other technologies such as multi-touch and gesture-based touchscreens are also premised on capacitive sensing.

A capacitive touchscreen panel is one which consists of an insulator such as glass, coated with a transparent conductor such as indium tin oxide (ITO). As the human body is also a conductor, touching the surface of the screen results in a distortion of the screen's electrostatic field, measurable as a change in capacitance. Different technologies may be used to determine the location of the touch. Although it is known to use capacitive touch sensors built on front of the display viewing area, the sensor structure decreases the output brightness of the whole display system. The sensors are also always reflecting and absorbing some light, which decreases contrast of the display in bright environments.

In the past, “inductive” touch (using Electro-magnetic resonance, EMR) has been used under a display, but it can be used only with a special stylus and needs a special resonance circuit to be placed into stylus or pen.

### SUMMARY

The following summary is merely intended to be exemplary. The summary is not intended to limit the scope of the claims.

In accordance with one aspect, an apparatus is provided including an electronic display having an electrical display section located behind a front window; and a capacitive touch sensor located behind the electrical display section. The electrical display section is configured to display information to a user at the front window. The capacitive touch sensor is configured to sense presence of a finger of the user at the front window.

In accordance with another aspect, a method is provided comprising providing an electronic display having a front side and a back side, where the electronic display is configured to display information to a user at the front side; and connecting a capacitive touch sensor to the display at the back side of the display, where the capacitive touch sensor is configured to sense presence of a finger of the user at the front side of the display.

In accordance with another aspect, a method is provided comprising, when a user positions a finger at a front side of an electronic display, sensing presence of the finger by a capacitive touch sensor located at a back side of the electronic display; and sending an electrical signal by the capacitive touch sensor based upon the sensed presence of the finger.

### BRIEF DESCRIPTION OF THE DRAWINGS

The foregoing aspects and other features are explained in the following description, taken in connection with the accompanying drawings, wherein:

FIG. 1 is a perspective view of an example embodiment;

FIG. 2 is a schematic sectional view of components of the touch screen shown in FIG. 1;

FIG. 3 is a schematic section view of the touch sensor shown in FIG. 2 without showing the display;

FIG. 4 is a plan bottom view of the touch sensor shown in FIG. 3;

FIG. 5 is a diagram illustrating some steps of one example method;

FIG. 6 is a diagram illustrating some steps of another example method;

FIG. 7 is a partial sectional view illustrating extension of the touch sensor beyond a side edge of the display;

FIG. 8 is a top view of the apparatus shown in FIG. 7;

FIG. 9 is a schematic section view of a touch sensor similar to FIG. 3 showing an alternate design;

FIG. 10 is a schematic sectional view of an alternate embodiment of the display and touch sensor assembly;

FIG. 11 is a schematic end view of embodiment shown in FIG. 10;

FIG. 12 is a schematic sectional view of another alternate embodiment of the display and touch sensor assembly;

FIG. 13 is a schematic sectional view of the assembly shown in FIG. 12 attached to an apparatus;

FIG. 14 is a schematic sectional view of an alternate embodiment of a touch screen which includes a pressure sensor; and

FIG. 15 is a schematic sectional view of the embodiment shown in FIG. 14 without showing the display.

### DETAILED DESCRIPTION OF EMBODIMENTS

Although features will be described with reference to the example embodiments shown in the drawings, it should be understood that the features may be embodied in many alternate forms of embodiments. In addition, any suitable size, shape or type of elements or materials could be used.

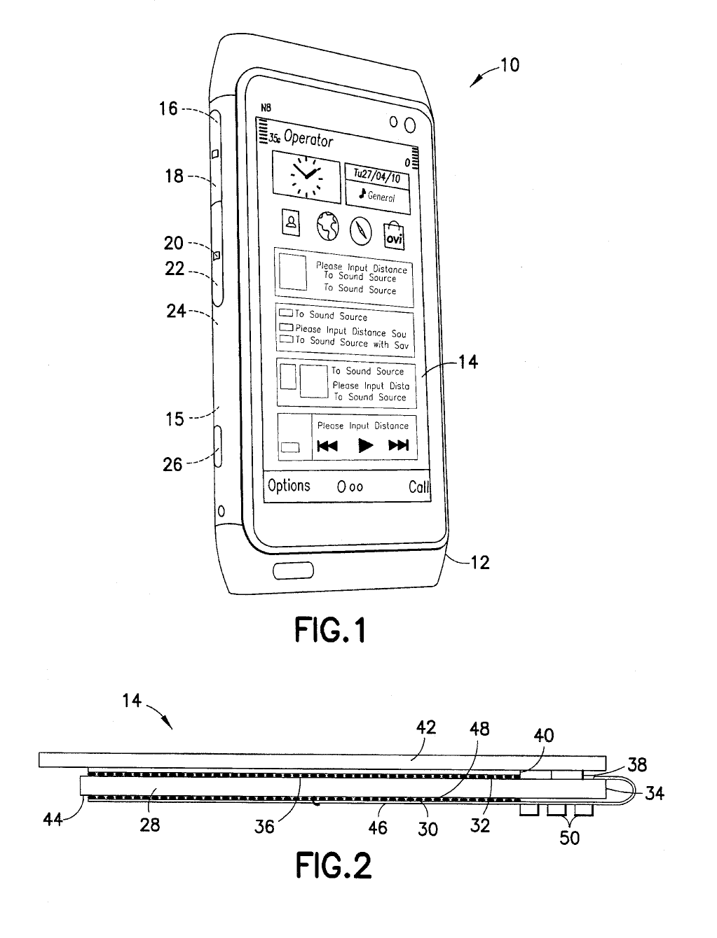

Referring to FIG. 1, there is shown a perspective view of an apparatus 10 according to an example embodiment. In this example the apparatus 10 is a hand-held portable apparatus comprising various features including a telephone application, Internet browser application, camera application, video recorder application, music player and recorder application, email application, navigation application, gaming application, and/or any other suitable electronic device application. The apparatus may be any suitable portable electronic device, such as a mobile phone, computer, laptop, PDA, etc.

The apparatus 10, in this example embodiment, comprises a housing 12, a touch screen 14 which functions as both a display and a user input, and electronic circuitry including a printed wiring board 15 having at least some of the electronic circuitry thereon. The electronic circuitry can include, for example, a receiver 16, a transmitter 18, and a controller 20. The controller 20 may include at least one processor 22, at least one memory 24, and software. A rechargeable battery 26 is also provided.

Referring also to FIG. 2, the touch screen 14 comprises an electronic display 28 and a touch sensor 30. The electronic display 28, in this example embodiment, is a (AM)OLED (Active Matrix Organic Light Emitting Diode) with thin film encapsulation. However, in an alternate embodiment features could be used with other types of displays. The electronic display 28 has a top member 32, a base member 34 and OLED (Organic Light Emitting Diode) material 36 as the electrical display section located between the top and base members. The top member 32 forms an encapsulation of the display. The electrical display section formed by the OLED material is located behind the encapsulation. The electrical display section 36 is configured to display information to a user at the front window. In one type of example embodiment, the encapsulation forms at least part of the front window.

The top member 32 is a very thin encapsulation (also known as a thin film encapsulation), such as made of glass or polymer material. The OLED material is encapsulated, otherwise the lifetime of the OLED is decreased dramatically if contacted with air. The base member 34, in this example embodiment, includes a glass or plastic substrate for example. In this example a display integrated circuit (IC) 38 is provided on the base member 34 as a chip-on-glass. However, in an alternate embodiment the display IC need not be provided on the base member. This example embodiment also comprises a polarizer 40 for optical enhancement, and a decorative/protective window 42.

The touch sensor 30 is a capacitive touch sensor. Unlike a conventional capacitive touch sensor used with a display to form a touch screen, the capacitive touch sensor 30 is not located at the top member of the display. Instead, the capacitive touch sensor 30 is located behind the electrical display section formed by the OLED material 36. In this example the capacitive touch sensor 30 is located on a back side 44 of the electronic display 28; at the rear side of the base member 34. The capacitive touch sensor 30 in this example comprises a printed wiring board (PWB) 46 with electrical conductors 48 forming touch sensor wires on the PWB.

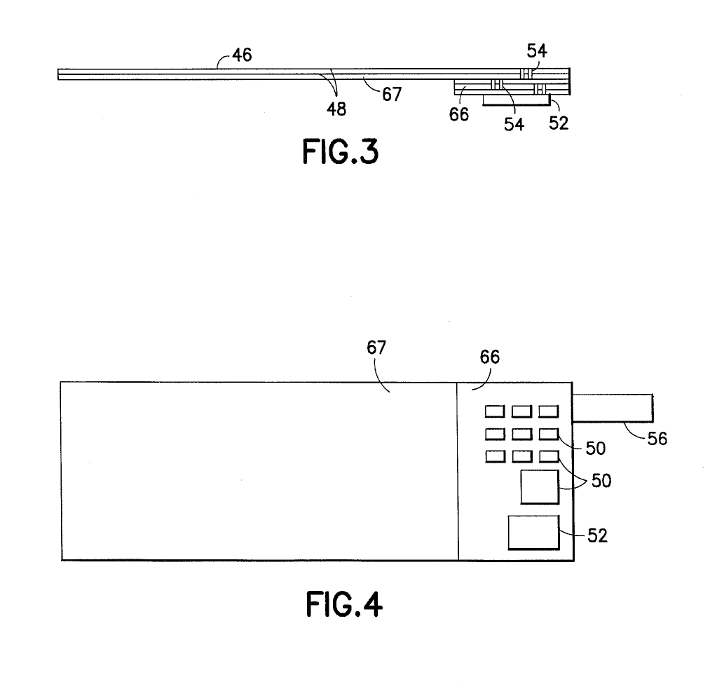

Referring also to FIGS. 3-4, the touch sensor is shown without the display 28. In this example embodiment the PWB 46 is a flexible PWB and the conductors 48 comprise metal traces, such as copper traces. However, the PWB could be a non-flexible printed wiring board, and the conductors could be any suitable conductor patter on the board. FIG. 3 shows that vias 54 may be used to connect different sensor layers to the main touch routing, touch IC and display main flex routing. FIG. 4 also shows that one electrical interface 56 can be provided to the handset electronics. Display related electrical components 50 (such as touch and OLED related) and a touch IC 52 may be provided on the PWB 46. Thus, the PWB 46 may have a first section with the capacitive touch sensor conductors 48 forming the sensor 30 and a second section forming a display main electrical component mounting area for the components 50, 52.

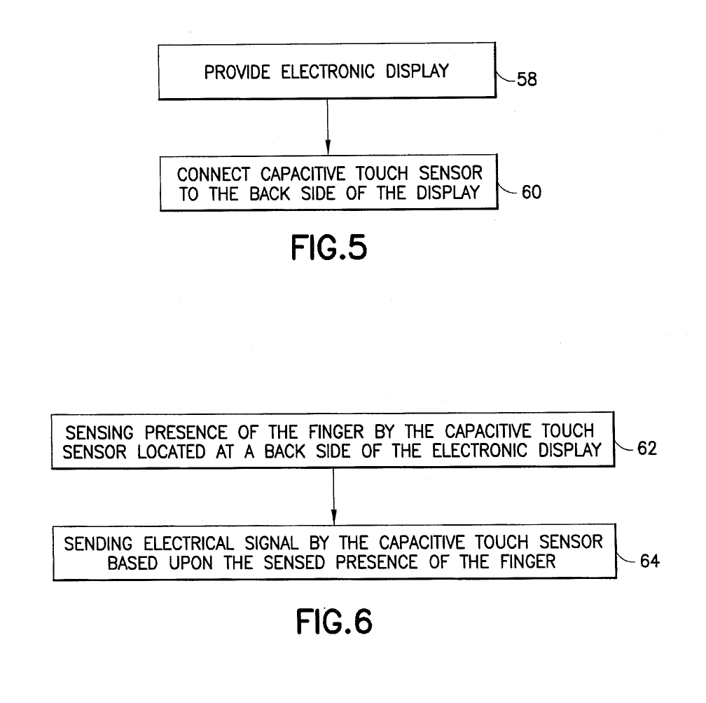

Referring also to FIG. 5, an example method includes providing an electronic display having a front side and a back side as indicate by block 58, where the electronic display is configured to display information to a user at the front side; and connecting 60 a capacitive touch sensor to the display at the back side of the display, where the capacitive touch sensor is configured to sense presence of a finger of the user at the front side of the display. Referring also to FIG. 6, an example method includes, when a user positions a finger at a front side of an electronic display, sensing presence 62 of the finger by the capacitive touch sensor 30 located at a back side of the electronic display 28; and sending 64 an electrical signal by the capacitive touch sensor based upon the sensed presence of the finger.

Capacitive touch sensor location affects the perceived optical quality of the display. The example embodiments describe a method of using, for example, a flexible-PWB (as part of the display main flex or connected to the display main flex or engine board) as a sensor member carrying at least one sensor layer. The example embodiment described above uses an AM-OLED display as an example to describe the integration, but the features described herein could be used in all thin display constructions.

With the example embodiment described above one or more capacitive touch sensors can be placed behind the display panel. The capacitive touch sensor(s), in one type of example embodiment is located under the display panel with an already fabricated flexible PWB 46 placed on an already construed OLED display structure. Thus, the touch sensor 30 can be attached to the display as a sub-assembly where the display 28 is supplied as a fully assembled sub-assembly module.

The features described herein may be used for the coming evolution of OLED display technology; where the encapsulation glass as the top member 32 is not used and the base member 34 is made thinner by using plastic film instead of glass. The display main component area (see FIG. 4) can be, for example, parallel to the sensor area 67 or below it. Electrical connection to the handset engine board can be handled through one connection flex 56. One or more capacitive touch sensors may be located under the display panel(s) as a separate touch sensor circuit (for example on the PWB). This may be electrically connected to the display flex-PWB or handset engine PWB.

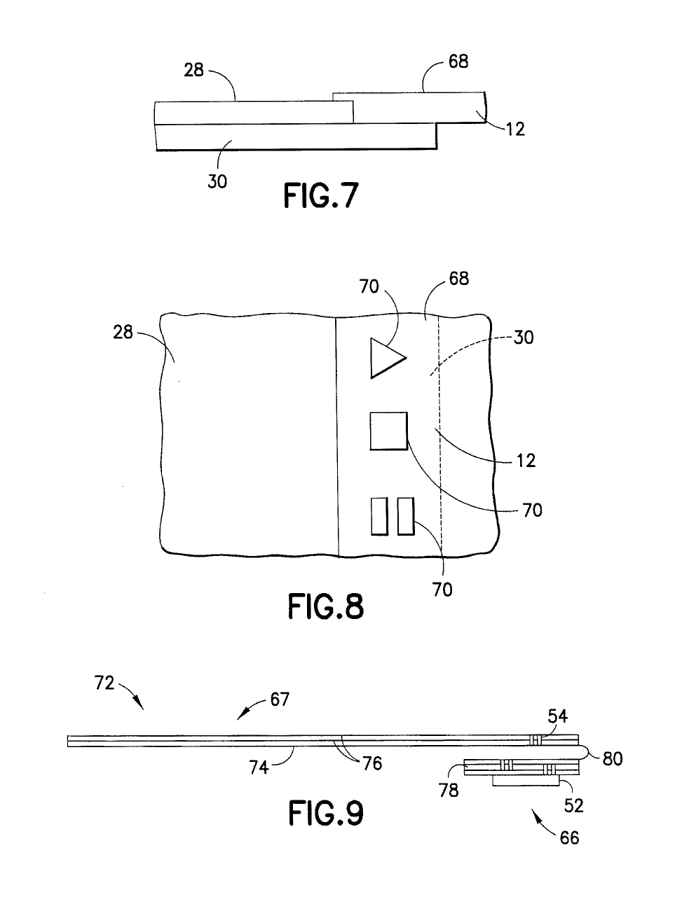

In one type of example embodiment the flex-PWB 46 of the sensor 30 may be used as a part of a flexible display. In one type of example embodiment the flex-PWB 46 may be provided larger than the display for possible handset edge area sensing or even handset backside area sensing if the flex-PWB is bent around to the backside area of the handset 10. As seen in FIGS. 7-8, in one type of example embodiment one or more areas 68 of the apparatus housing 12 overlapping the sensor 30 at the edge of the display 28 could be used to support features for permanent keys (such as audio-visual control keys 70 for example). Housing areas 68 overlapping an edge of the display area could be also optimized for other functions, such as proximity sensing or hovering sensing for example. In one type of example embodiment a pressure or force sensing function may be integrated on the same flex-PWB 46 as the touch sensing function. This approach enables reducing the layers of the touch screen compared to the example where those two features (touch sensing and pressure sensing) are done using separate PWB members.

With use of features described herein, the sensor circuit material does not have to be transparent as in existing transparent capacitive sensor systems at the front of the display. The touch sensor circuit can be done, for example, using a common flex-PWB. Connections through layers towards the touch main routing and display main flex-PWB routing can be done using vias 54. Manufacture of the sensor circuit may be done using methods and materials mentioned above which allows for more complex and efficient circuits compared to optically transparent capacitive touch sensors. For example, all of the touch sensor pads can have a separate tracking line to the touch sensor Integrated Circuit (IC). The sensor circuit design may also be optimized to maximize sensitivity because visibility through the sensor 30 does not have to be taken into account.

With the use of an example embodiment existing touch feature sets, such as multi-touch sensing, does not need to be reduced. No touch sensors need be located in the optical path from the display to the end-user's eyes. However, in one type of alternate embodiment the rear located touch sensor 30 could be used in an apparatus which also has a display with a conventional see-through front touch sensor section. Thus, both touch sensing designs could be used in a single apparatus; overlapping each other and/or not overlapping each other.

With the rear located touch sensor described above, this means better contrast and higher brightness for the display. Low resistance, low capacitance and low inductance metallic tracks can be used as sensors circuit material for the conductors 48. Flexible PWBs are naturally flexible (or even dynamic) to make flexible/curvature structures. Using dynamic flexes, dynamic touches (for example in rollable display integrations) may be provided in some example embodiments. Processes for manufacturing a flex-PWB (for example metallization) may be used in some example embodiments which are less expensive than an ITO process for a see-through touch sensor. In addition, the availability of the PWB materials are better than optically transparent conductive materials (such as ITO) which can reduce manufacturing costs. Also processes to manufacture a PWB (non-flex and flex) can be more environmentally friendly than other processes, such as ITO processes for a see-through touch sensor.

Example embodiments can enable thinner and more robust constructions. Sensor circuits done using high conductive materials, and lack of transparency requirement, allows much more sensitive circuits compared to optically transparent sensors. High electrically conductive tracking enables faster read-out rate compared to optically transparent sensors. This makes it possible to use a high resolution display and touch synchronization more easily. Example embodiments can enable design of a touch sensor which is larger than the display, and bending of the sensor for possible handset edge area sensing, or even handset backside area sensing.

Example embodiments can enable more sensitive proximity and hovering features for the touch. Example embodiments can enable the usage of gloves on the user's hand during touching. Existing transparent front display panel touch sensor solutions do not prefer use of gloves on the user's hand. With an example embodiment, a high signal-to-noise ratio can be achieved with high conductive tracking being used instead of transparent sensors. A high signal-to-noise (SNR) ratio enables the ability to sense touch when the touch sensor is behind the display rather than on the front of the display. Example embodiments can provide a fully optimized sensor circuit design with no transparency requirement. Sensing may be done when the display is quiet or inactive. Also, use of low noise differential measurement amplifier with high CMRR (common mode rejection ratio) and use of guard electrode to even out slow common mode bias voltage to avoid overdriving measurement amplifier inputs, may be used.

Referring also to FIG. 9, an example embodiment is shown similar to FIG. 3 without showing the display 28 where the capacitive touch sensor(s) 72 may be located under the display panel as a separate touch sensor (for example on a PWB 74). This is electrically connected to the display flex-PWB or handset engine PWB. The PWB 74 may have metallic touch sensor wires 76 (one or several). A separate PWB 78 having the touch IC 52 and display related electrical components 50 (see FIG. 4) may be provided to form the display main component area 66, and connected to the sensor PWB 74 by a electrical connection 80 between the touch flex and display main flex (which can also be directly connected to the handset engine board).

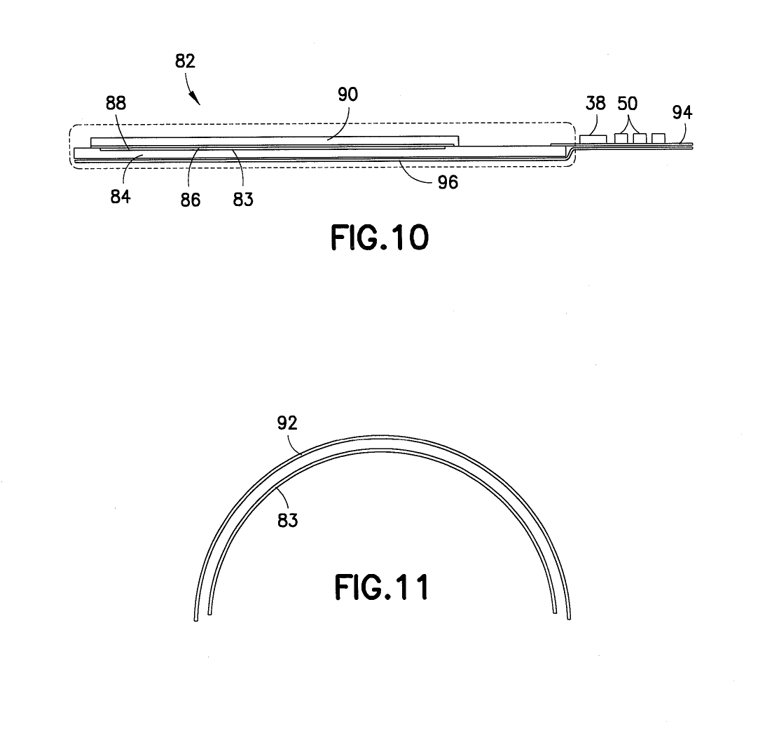

Referring also to FIGS. 10-11, as noted above features could be used to provide a curved design. In this example embodiment the display 82 forms a touch screen 83 comprises a base member 84, an electrical display section 86 formed by an OLED structure, a thin film encapsulation 88 of the display, and an optional polarizer 90 for optical enhancement. A decorative/protective window 92, such as made of plastic or glass for example, may be provided over the touch screen 83. In this example embodiment the display electronic components 38, 50 may be provided as a chip-on-flex configuration on a flex PWB 94 attached to the base member 84. The flex PWB 94 may be folded under the base member. The capacitive touch sensor 96 comprises a flex-PWB with metal conductors as the touch sensors. The touch sensor 96 is attached to the rear/bottom side of the base member 84 and may be connected to the PWB 94. The display 82 comprises a flexible OLED, for example, to achieve the curvature design. Laminations between the window 92, the display 82 and the touch sensor 96 may be used.

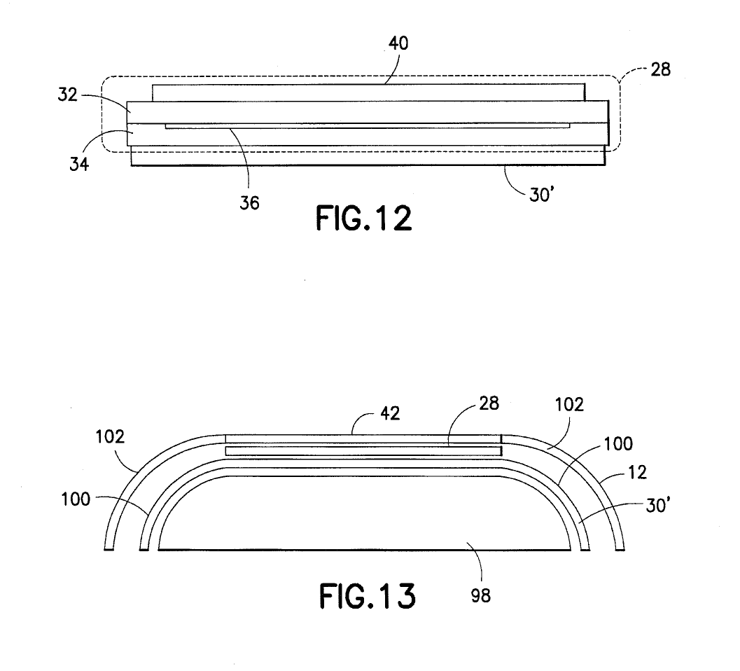

Referring also to FIGS. 12-13, as noted above features could be used to provide a design where the touch sensor is larger (extends past an edge) of the display. In this example embodiment the apparatus comprises a housing 12, a display 28, a decorative/protective window 42, a capacitive touch sensor 30′, and an optional support structure 98. The display 28 has the base member 34, electrical display section 36 formed by an OLED structure, top member 32 forming at least part of a front window of the display, and an optional polarizer 40 for optical enhancement. In one type of example, an additional window pane is provided on top of the polarizer 40 similar to 42 in FIG. 2. The touch sensor 30′ is connected to the rear side of the base member 34. As seen best in FIG. 13, the touch sensor 30′ is larger than the display 28 such that sections 100 extend beyond the side edges of the display 28 along sections 102 of the housing 12. Thus, sections 100/102 can be used for user input in the apparatus by means of the capacitive touch sensor spaced from the display.

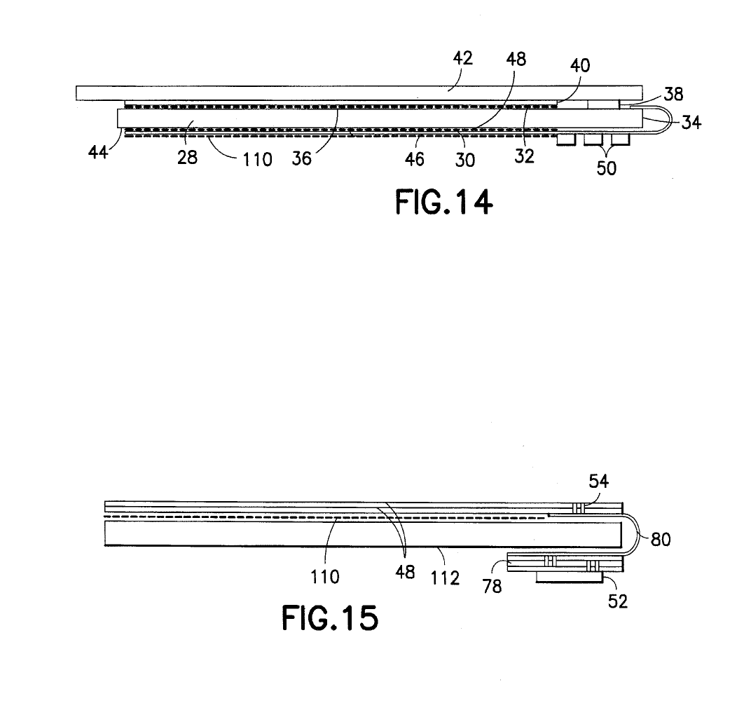

Referring also to FIGS. 14-15, as noted above features could be used to provide a design where, in addition to touch sensing, pressure sensing or force sensing is also available. In this example embodiment the apparatus comprises the display 28, the touch sensor 30, the optional polarizer 40, the optional decorative/protective window 42, IC 38, electrical components 50, and a pressure sensing section 110. As seen in FIG. 15, a support 112 under the pressure sensor section 110 may also be provided. The display 28 comprises the top member 32, the base member 34 and OLED (Organic Light Emitting Diode) material as the electrical display section 36 located between the top and base members. The touch sensor 30 is located at the rear side of the base member 34 and comprises the PWB 46 with the metal conductors 48 forming the metallic touch sensors. The pressure sensing section 110 may be integrally formed on the PWB 46 or could be supplied as a separate member which is connected to the rear side of the touch sensor 30. For this type of embodiment the display would need to be flexible so that deflection of a portion of the display could be translated to deflection of a portion of the pressure sensing section 110. In one type of alternate embodiment the touch sensor and/or pressure sensor could be integrated, at least partially, in the base member 34.

An example embodiment comprises an apparatus 10 including an electronic display 28 having an electrical display section 36 located behind a front window 40 or 42, where the electrical display section is configured to display information to a user at the front window; and a capacitive touch sensor 30 located behind the electrical display section 36, where the capacitive touch sensor is configured to sense presence of a finger of the user at the front window.

The capacitive touch sensor may be located on a back side of the electronic display 28. The electronic display 28, in one example, comprises a front window as a top member and a substantially rigid base member 34, where the electrical display section 36 is located between the top member 32 and the base member 34, and where a rear side of the base member forms the back side of the electronic display 28. The front window 32 and/or 40 and/or 42 may be substantially rigid. The electronic display 28 may be flexible. The apparatus may further comprise a force sensor 110 configured to sense force applied by the finger at the front window. The capacitive touch sensor, in one example, comprises a printed wiring board 46 behind the electronic display section 36. The capacitive touch sensor 30, in one example, comprises electrical conductors 48 forming touch sensor wires on the printed wiring board. The printed wiring board, in one example, comprises a flexible printed wiring board. The capacitive touch sensor 30′ may extends beyond at least one side edge of the electronic display 28 to sense the presence of the finger beyond the at least one side edge of the electronic display. The capacitive touch sensor 96 may be at least partially non-planar. The electronic display 82 may be at least partially curved. The electrical display section, in one example, comprises an organic light emitting diode, and the capacitive touch sensor may be located behind the organic light emitting diode.

An example method may be provided comprising providing an electronic display having a front side and a back side, where the electronic display is configured to display information to a user at the front side; and connecting a capacitive touch sensor to the display at the back side of the display, where the capacitive touch sensor is configured to sense presence of a finger of the user at the front side of the display. The step of providing the electronic display, in one example, comprises providing the electronic display with a front window as a top member which is substantially rigid. The step of providing the electronic display, in one example, comprises providing the electronic display with as a flexible electronic display. The method may further comprise connecting a force sensor to the electronic display, where the force sensor is configured to sense force applied by the finger at the front window. The step of connecting the capacitive touch sensor to the display, in one example, comprises the capacitive touch sensor comprising a printed wiring board, where the printed wiring board is attached against the back side of the display. The step of connecting the capacitive touch sensor to the display, in one example, comprises the capacitive touch sensor comprising electrical conductors forming touch sensor wires on the printed wiring board, where the sensor wires are placed against the back side of the display. The step of connecting the capacitive touch sensor to the display, in one example, comprises the capacitive touch sensor extending beyond at least one side edge of the electronic display to sense the presence of the finger beyond the at least one side edge of the electronic display. The method may further comprise bending the electronic display and capacitive touch sensor together. The step of providing the electronic display, in one example, comprises providing the electronic display with an organic light emitting diode, and the capacitive touch sensor is connected to the display behind the organic light emitting diode.

Some example embodiments comprise a capacitive touch sensor provided behind the display. This removes the need for the touch sensor to be transparent. Because metal wire touch sensors can be used instead of ITO, sensitivity of the touch sensor is improved. When properly calibrated, a touch sensing display can sense touch through a thin-film display. A touch sensor according to example embodiments may be provided as a flexible wiring board also comprising display electronics. An example feature is a capacitive touch sensor placed under a thin-film display and configured to sense touch or proximity through the display. An apparatus can be provide comprising a thin-film display and a capacitive touch sensor provided under the display and configured to sense touch or proximity through the display. Integration of the sensor flex 46 with the display flex 94 may be provided.

In order to track finger movements, such as during a process or application which uses finger tracking for example, the controller 20 may have suitable software and be configured to filter out static (non-moving) touch.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1. An apparatus comprising:
an electronic display having an electrical display section located behind a front window, where the electrical display section is configured to display information to a user at the front window; and
a capacitive touch sensor located behind the electrical display section, where the capacitive touch sensor is configured to sense presence of a finger of the user at the front window.

2. An apparatus as in claim 1 where the capacitive touch sensor is located on a back side of the electronic display.

3. An apparatus as in claim 2 where the electronic display comprises the front window as a top member and a substantially rigid base member, where the electrical display section is located between the top member and the base member, and where a rear side of the base member forms the back side of the electronic display.

4. An apparatus as in claim 1 comprising means, connected to the electronic display and located behind the electrical display section, for sensing touch of the finger on the apparatus.

5. An apparatus as in claim 1 where the electronic display is flexible.

6. An apparatus as in claim 1 where the apparatus further comprises a force sensor configured to sense force applied by the finger at the front window.

7. An apparatus as in claim 1 where the capacitive touch sensor comprises a printed wiring board behind the electronic display section.

8. An apparatus as in claim 7 where the capacitive touch sensor comprises electrical conductors forming touch sensor wires on the printed wiring board.

9. An apparatus as in claim 7 where the printed wiring board comprises a flexible printed wiring board.

10. An apparatus as in claim 1 where the capacitive touch sensor extends beyond at least one side edge of the electronic display to sense the presence of the finger beyond the at least one side edge of the electronic display.

11. An apparatus as in claim 1 where the capacitive touch sensor is at least partially non-planar.

12. An apparatus as in claim 1 where the electronic display is at least partially curved.

13. An apparatus as in claim 1 where the electrical display section comprises an organic light emitting diode, and the capacitive touch sensor is located behind the organic light emitting diode.

14. A method comprising:
providing an electronic display having a front side and a back side, where the electronic display is configured to display information to a user at the front side; and
connecting a capacitive touch sensor to the display at the back side of the display, where the capacitive touch sensor is configured to sense presence of a finger of the user at the front side of the display.

15. A method as in claim 14 where the step of providing the electronic display comprises providing the electronic display with a front window as a top member which is substantially rigid.

16. A method as in claim 14 where the step of providing the electronic display comprises providing the electronic display with as a flexible electronic display.

17. A method as in claim 14 further comprising connecting a force sensor to the electronic display, where the force sensor is configured to sense force applied by the finger at the front window.

18. A method as in claim 14 where the step of connecting the capacitive touch sensor to the display comprises the capacitive touch sensor comprising a printed wiring board, where the printed wiring board is attached against the back side of the display.

19. A method as in claim 14 where the step of connecting the capacitive touch sensor to the display comprises the capacitive touch sensor comprising electrical conductors forming touch sensor wires on the printed wiring board, where the sensor wires are placed against the back side of the display.

20. A method as in claim 14 where the step of connecting the capacitive touch sensor to the display comprises the capacitive touch sensor extending beyond at least one side edge of the electronic display to sense the presence of the finger beyond the at least one side edge of the electronic display.

21. A method as in claim 14 further comprising bending the electronic display and capacitive touch sensor together.

22. A method as in claim 14 where the step of providing the electronic display comprises providing the electronic display with an organic light emitting diode, and the capacitive touch sensor is connected to the display behind the organic light emitting diode.

23. A method comprising:
when a user positions a finger at a front side of an electronic display, sensing presence of the finger by a capacitive touch sensor located at a back side of the electronic display; and
sending an electrical signal by the capacitive touch sensor based upon the sensed presence of the finger.
